(19) United States
(12) Patent Application Publication
(10) Pub. No.: US 2023/0410800 A1
(43) Pub. Date: Dec. 21, 2023

(54) CONTROLLING A USER INTERFACE USING NATURAL LANGUAGE PROCESSING AND COMPUTER VISION

(71) Applicant: LENOVO (SINGAPORE) PTE. LTD, Singapore (SG)

(72) Inventors: Timothy Robbins, Avon, IN (US); Matthew Fardig, Boonville, IN (US)

(21) Appl. No.: 17/842,074

(22) Filed: Jun. 16, 2022

(51) Int. Cl. G10L 15/22; G10L 15/02; G06F 3/0484

(52) U.S. Cl. CPC G10L 15/22; G10L 15/02; G06F 3/0484; G10L 2015/223

(57) ABSTRACT

A user provides an audible command and an audible description of an element on a computer graphical user interface (GUI) into a natural language processor (NLP). The NLP extracts from the audible description features of the element on the computer GUI. A screenshot of the computer GUI is transmitted to a computer vision platform, and the computer vision platform provides a map of features of the GUI elements that are displayed on the computer GUI. The features of the element on the computer GUI are compared with the features of the plurality of GUI elements on the map. A match between the features of the element on the computer GUI and the features of the GUI elements on the map is identified, and the audible command is executed in connection with the matched GUI element.

### TECHNICAL FIELD

Embodiments described herein generally relate to controlling a computer user interface using natural language processing and computer vision.

### BACKGROUND

One of the most frustrating problems when working with a computer can be trying to instruct another person what actions to perform on that person's computer screen. For example, in a conference, a first user might be sharing his screen and a second user is helping to solve a problem. The second user tells the first user to click a certain icon and the first user doesn't understand what the second user is describing. It leads to conversations such as “This one?” or “That one?” followed by “No, look to the left . . . no, down a little . . . the red button . . . no don't right click it, left click it”, etc. Essentially, the users are attempting to describe what to click or what other action to take. This relies on the second user being able to adequately describe what to click or do, and the first user being able to understand what is being said, and then being able to perform the action required. This can be especially difficult in complex interfaces with a lot of options, and also in situations where language is a barrier. In effect, this can make online sharing or training sessions very difficult.

Likewise, similar frustrations can occur even during non-sharing situations for users with various accessibility requirements who aren't able to operate a traditional mouse or touch pad. The user can clearly see the option they want on the screen, but with traditional accessibility options, they can still find it difficult to click or activate the desired option.

Additionally, such accessibility navigation can be clunky and unnatural. For example, Microsoft Windows® offers features such as keyboard shortcuts to access various options, and sticky keys to make it easier to activate shortcuts. Other options read text items out loud to a user, or the other options allow the user to use the keyboard to navigate (e.g., tab 3 times, press enter). This can be very frustrating for users as they are limited to the predefined options. The user might be looking right at the option that they want to click on the screen, but they struggle to get that option selected or highlighted.

Remote control is currently a common way to solve this problem during conferences with screen sharing. This allows a remote user to take control of the keyboard and mouse on the system that is sharing its screen. However, this typically requires special software to be installed on both systems. Also, a user may just want help regarding what to click on. The user may not want someone to take complete control over his or her computer.

In conferencing applications, there are other current options such as disappearing pens or laser pointers that can be used to allow a remote user to highlight a particular area of the screen. However, these notations only last for a few seconds and then they disappear. Also, problems can arise when a first user is highlighting a screen element on a second user's screen while the second user is scrolling up or down on the screen.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is an example of a screen shot of a computer graphical user interface (GUI).

FIGS. 2A and 2B are a block diagram of features and operations of a system that uses natural language processing and computer vision to control a user interface.

FIG. 3 is a block diagram of a computer architecture upon which one or more embodiments of the present disclosure can execute.

### DETAILED DESCRIPTION

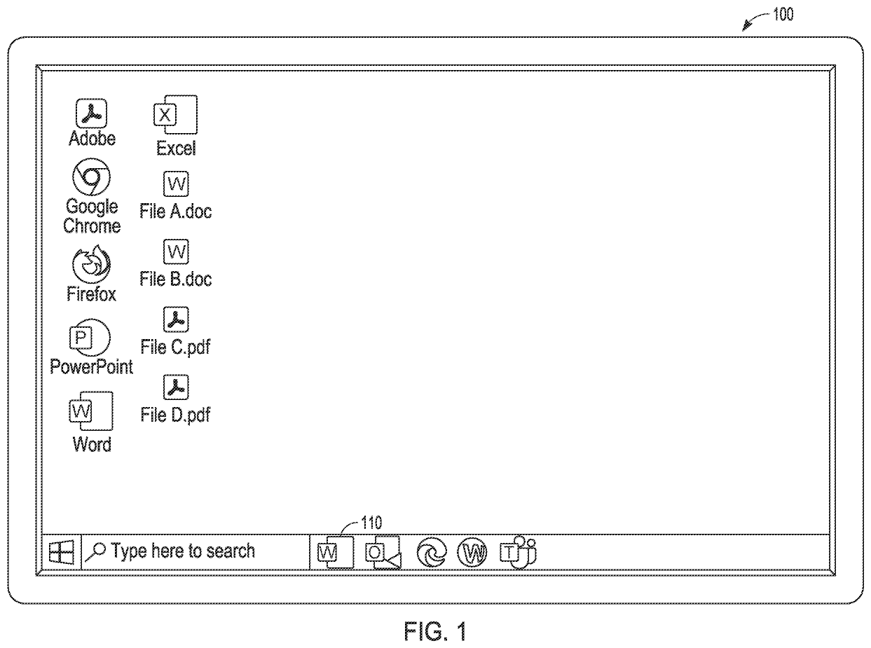

An embodiment of the present disclosure uses natural language processing (NLP) and computer vision platforms to locate interface elements on a computer graphical user interface (GUI), such as the GUI 100 illustrated in FIG. 1. The use of NLP allows a user to describe actions in an intuitive, natural, and universal manner by identifying such aspects as the color of, the location of, the shape of, and any text associated with, the interface elements. The NLP converts this audible user-supplied description into some processable data format. This data format can then be compared with a similar data format of the elements on the entire GUI, which can be generated by a computer vision platform such as Amazon Rekognition, which can analyze an image or screenshot and return coordinates, text, and other identifiers or features for everything on the screen. This allows a user to verbally describe what element they want, what action to perform on that element, and allows the system to find it with a high degree of confidence (or for the user to provide more information if the system identifies no match for an element or more than one possible match for an element).

An embodiment can be described in another form as follows. First, a user speaks and describes the element on the screen with which they want to interact. Second, the NLP takes that speech and pulls out the features or identifiers of the element (that is, location, color, shape, text, etc.). Third, a screenshot of the GUI is sent to a computer vision platform, and a map of the elements on the screen is returned. Fourth, the features or identifiers that were spoken and described by the user are matched up with the map returned by the computer vision platform in order to locate the best match for the element that the user described. Finally, the system then performs the requested action on that element.

There are several uses of and situations for the various embodiments of the present disclosure. For example, regarding accessibility, a user could be using a Windows computer, and the user wants to click on the Word icon in the toolbar. The user could simply say “click the square with the several horizontal shades of blue rectangles within it and the overlain blue square with the white ‘W’ in it.” In other accessibility situations, a person may, for one reason or another, simply not be able to use a keyboard or a mouse, and an embodiment can assist such a user.

Another use of an embodiment is for highlighting a screen share during a video conference. For example, a first user could be sharing their screen in a remote help session with a second user. The first user isn't sure where to click in the Teams app to unmute himself. The second user instructs the first user by saying “click the rectangle with the red microphone icon that has a circle around it.” On the first user's screen, that icon becomes highlighted so that the first user can easily find it.

An embodiment could further be used in connection with remote control during a video conference. Using the same scenario as in the previous paragraph, when the second user describes the GUI feature and/or action, that option is automatically clicked on the first user's computer. This allows a viewer (when granted rights) to remotely control another user's screen. Because this is all based on the audio in the conference, the second user doesn't even have to be near a computer to do this. The second user could be in their car, talking on their cell phone, and still control the first user's screen.

An embodiment could still further be used for television and/or media device navigation. For example, on Amazon FireTV, a user can define certain sets of commands that the Alexa system can understand. For example, “Alexa, open Netflix.” However, the use of the Alexa system requires foreknowledge of what commands should be supported so that support can be added. However, this often leads to a situation where different apps require different sets of commands. This is very confusing to the end user. With this embodiment however, the user could simply say “click the white rectangle with the red N in it” in order to open Netflix.

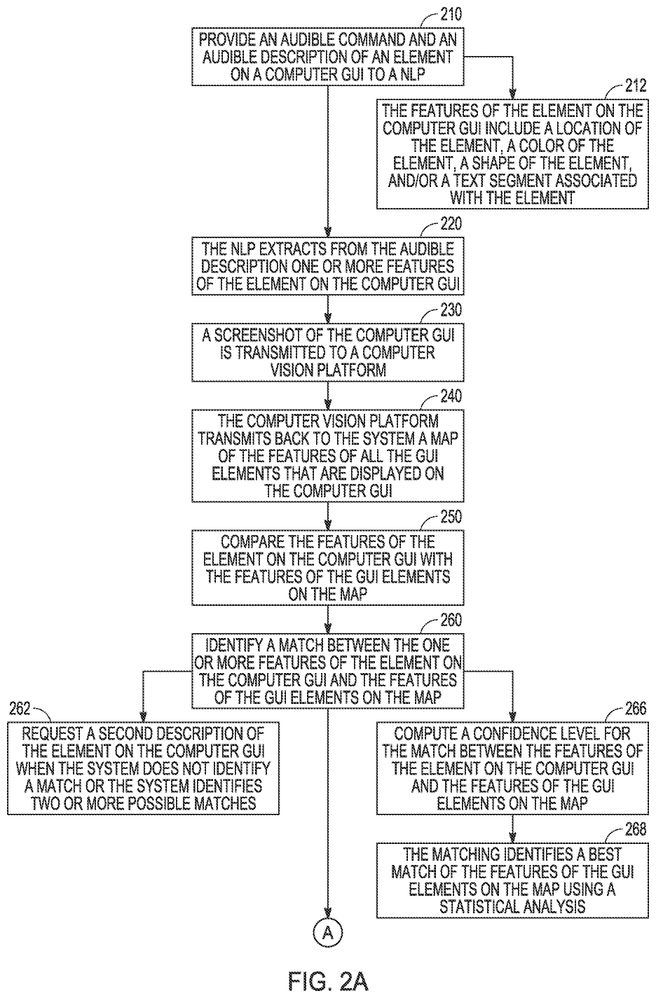

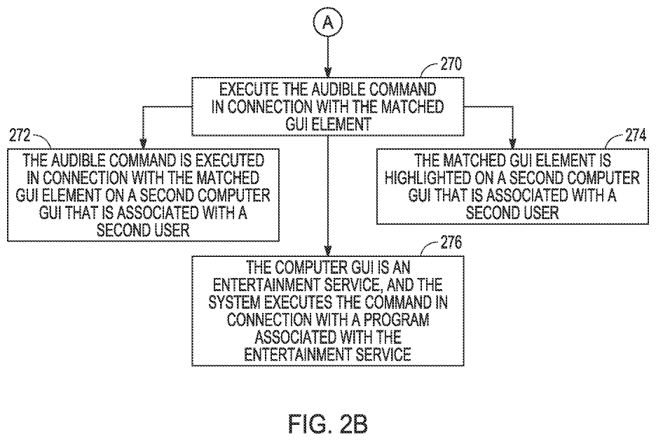

FIGS. 2A and 2B are a block diagram illustrating operations and features of a system to control a user interface with natural language processing and computer vision. FIGS. 2A and 2B include a number of feature and process blocks 210-276. Though arranged substantially serially in the example of FIGS. 2A and 2B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Now, referring specifically to FIGS. 2A and 2B, at 210, a user provides an audible command and an audible description of an element on a computer graphical user interface (GUI) to a natural language processor (NLP). As indicated at 212, the features of the element on the computer GUI (and as indicated below the features of the plurality of GUI elements on a map returned from a computer vision interface) can include such things as a location of the element, a color of the element, a shape of the element, and/or a text segment associated with the element. For example, referring to the graphical user interface 100 in FIG. 1, the user may describe the Microsoft Word® icon 110, and state “click the square with the several horizontal shades of blue rectangles within it and the overlain blue square with the white ‘W’ in it.”

At 220, the NLP extracts from the audible description one or more features of the element on the computer GUI that the user just described. Then, at 230, a screenshot of the computer GUI is transmitted to a computer vision platform. This screenshot includes the entire screen and its contents including icons, toolbars, and the main display. The computer vision platform analyses the screenshot, and at 240, the computer vision platform transmits back to the system a map of the features of all the GUI elements that are displayed on the computer GUI.

At 250, the features of the element on the computer GUI (that was spoken by the user) are compared with the features of the GUI elements on the map. At 260, a match is identified between the one or more features of the element on the computer GUI and the features of the plurality of GUI elements on the map. The matching could take place on a client computer or in the cloud. When comparing text or words, in an embodiment, it could be required that there be an exact match between the text or words spoken by the user and the text or words returned as one of the features of the GUI element by the computer vision platform. In contrast, when comparing colors, for example, many different shades of a color may be considered as a match—red, cherry, apple, pink, fuchsia, etc. Also, in an embodiment, there can be universally recognized icons, such as a microphone icon for a mute feature, which is natural and intuitive and can be identified via simple text matching and not more complex shape matching.

It is possible that the system will not be able to identify a match. Consequently, as indicated at 262, the system can request and the user can provide a second description of the element on the computer GUI when the system does not identify a match, or the system identifies two or more possible matches. The system request can be provided to the user in an audible manner, or any other manner, such as a user interface notification. Similarly, the additional second description provided by the user is preferably audible, but it could also be non-audible, such as via a keyboard.

At 266, a confidence level can be computed for the match between the features of the element on the computer GUI and the features of the GUI elements on the map. Specifically, the system finds matches, which are determined by a configured, minimum confidence level. In an embodiment, non-matches will have a confidence of zero, and anything above zero is a possible match. However, a minimum confidence value could be established, such as for example a confidence level of 75%. If there are no matches that meet the set confidence level, or if more than a single match has the same or similar confidence level, the system will ask the user for more information. As indicated at 268, the matching identifies a best match of the GUI elements on the map using a statistical analysis. For example, the features of the elements (spoken by the user and identified by the computer vision platform) can be assigned mathematical values, and a least squares correlation can be executed to determine the best match.

Finally, at 270, the command that was spoken by the user is executed in connection with the matched GUI element. As indicated at 272, the command that was spoken by the user can be executed in connection with the matched GUI element on a second computer GUI that is associated with a second user. Similarly, at 274, the matched GUI element can be highlighted on a second computer GUI that is associated with a second user. As indicated at 276, in a particular embodiment, the computer GUI is an entertainment service, and the system executes the command in connection with a program associated with the entertainment service.

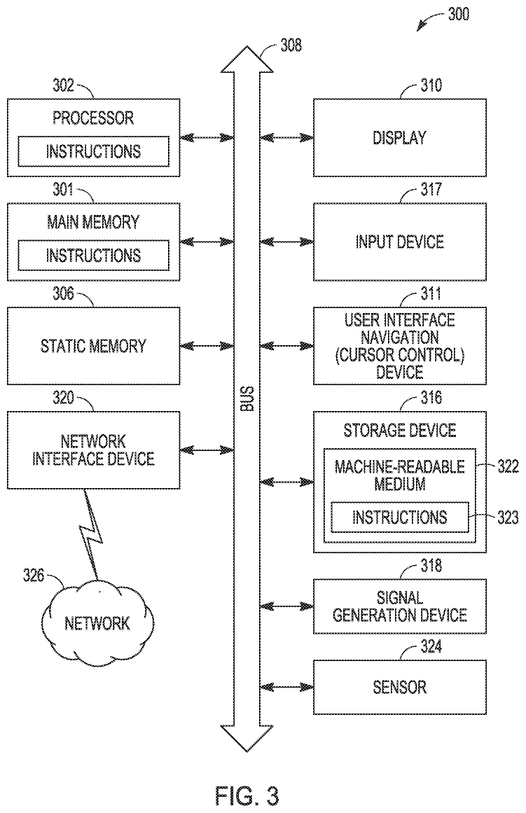

FIG. 3 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU) or both), a main memory 301 and a static memory 306, which communicate with each other via a bus 308. The computer system 300 may further include a display unit 310, an alphanumeric input device 317 (e.g., a keyboard), and a user interface (UI) navigation device 311 (e.g., a mouse). In one embodiment, the display, input device and cursor control device are a touch screen display. The computer system 300 may additionally include a storage device 316 (e.g., drive unit), a signal generation device 318 (e.g., a speaker), a network interface device 320, and one or more sensors 324, such as a global positioning system sensor, compass, accelerometer, or other sensor.

The storage device 316 includes a machine-readable medium 322 on which is stored one or more sets of instructions and data structures (e.g., software 323) embodying or utilized by any one or more of the methodologies or functions described herein. The software 323 may also reside, completely or at least partially, within the main memory 301 and/or within the processor 302 during execution thereof by the computer system 300, the main memory 301 and the processor 302 also constituting machine-readable media.

While the machine-readable medium 322 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 323 may further be transmitted or received over a communications network 326 using a transmission medium via the network interface device 320 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### Examples

Example No. 1 is a process for receiving into a natural language processor (NLP) from a user one or more of an audible command and an audible description of an element on a computer graphical user interface (GUI); extracting from the audible description one or more features of the element on the computer GUI; transmitting a screenshot of the computer GUI to a computer vision platform; receiving from the computer vision platform a map of a plurality of GUI elements that are displayed on the computer GUI; comparing the one or more features of the element on the computer GUI with the plurality of GUI elements on the map; identifying a match between the one or more features of the element on the computer GUI and the plurality of GUI elements on the map; and executing the command in connection with the matched GUI element.

Example No. 2 includes all the features of Example No. 1, and optionally includes a process wherein the one or more features of the element on the computer GUI and the plurality of GUI elements on the map comprise one or more of a location, a color, a shape, and a text segment.

Example No. 3 includes all the features of Example Nos. 1-2, and optionally includes a process for receiving a second audible description of the element on the computer GUI when the identifying a match identifies two or more matched GUI elements.

Example No. 4 includes all the features of Example Nos. 1-3, and optionally includes a process wherein the identifying the match identifies a best match from the plurality of GUI elements on the map using a statistical analysis.

Example No. 5 includes all the features of Example Nos. 1-4, and optionally includes a process for computing a confidence level for the match between the one or more features of the element on the computer GUI and the plurality of GUI elements on the map.

Example No. 6 includes all the features of Example Nos. 1-5, and optionally includes a process for highlighting the matched GUI element on a second computer GUI that is associated with a second user.

Example No. 7 includes all the features of Example Nos. 1-6, and optionally includes a process for executing the command in connection with the matched GUI element on a second computer GUI that is associated with a second user.

Example No. 8 includes all the features of Example Nos. 1-7, and optionally includes a process wherein the computer GUI comprises an entertainment service, and comprising executing the command in connection with a program associated with the entertainment service.

Example No. 9 is a machine-readable medium comprising instructions that when executed by a processor execute a process comprising receiving into a natural language processor (NLP) from a user one or more of an audible command and an audible description of an element on a computer graphical user interface (GUI); extracting from the audible description one or more features of the element on the computer GUI; transmitting a screenshot of the computer GUI to a computer vision platform; receiving from the computer vision platform a map of a plurality of GUI elements that are displayed on the computer GUI; comparing the one or more features of the element on the computer GUI with the plurality of GUI elements on the map; identifying a match between the one or more features of the element on the computer GUI and the plurality of GUI elements on the map; and executing the command in connection with the matched GUI element.

Example No. 10 includes all the features of Example No. 9, and optionally includes wherein the one or more features of the element on the computer GUI and the plurality of GUI elements on the map comprise one or more of a location, a color, a shape, and a text segment.

Example No. 11 includes all the features of Example Nos. 9-10, and optionally includes instructions for receiving a second audible description of the element on the computer GUI when the identifying a match identifies two or more matched GUI elements.

Example No. 12 includes all the features of Example Nos. 9-11, and optionally includes wherein the identifying the match identifies a best match from the plurality of GUI elements on the map using a statistical analysis.

Example No. 13 includes all the features of Example Nos. 9-12, and optionally includes instructions for computing a confidence level for the match between the one or more features of the element on the computer GUI and the plurality of GUI elements on the map.

Example No. 14 includes all the features of Example Nos. 9-13, and optionally includes instructions for highlighting the matched GUI element on a second computer GUI that is associated with a second user.

Example No. 15 includes all the features of Example Nos. 9-14, and optionally includes instructions for executing the command in connection with the matched GUI element on a second computer GUI that is associated with a second user.

Example No. 16 is a computer system including a processor and a memory coupled to the processor; wherein the processor and the memory are operable for receiving into a natural language processor (NLP) from a user one or more of an audible command and an audible description of an element on a computer graphical user interface (GUI); extracting from the audible description one or more features of the element on the computer GUI; transmitting a screenshot of the computer GUI to a computer vision platform; receiving from the computer vision platform a map of a plurality of GUI elements that are displayed on the computer GUI; comparing the one or more features of the element on the computer GUI with the plurality of GUI elements on the map; identifying a match between the one or more features of the element on the computer GUI and the plurality of GUI elements on the map; and executing the command in connection with the matched GUI element.

Example No. 17 includes all the features of Example No. 16, and optionally includes a computer system wherein the one or more features of the element on the computer GUI and the plurality of GUI elements on the map comprise one or more of a location, a color, a shape, and a text segment.

Example No. 18 includes all the features of Example Nos. 16-17, and optionally includes wherein the computer system is operable for receiving a second audible description of the element on the computer GUI when the identifying a match identifies two or more matched GUI elements.

Example No. 19 includes all the features of Example Nos. 16-18, and optionally includes wherein the computer system is operable for identifying the match identifies a best match from the plurality of GUI elements on the map using a statistical analysis; and for computing a confidence level for the match between the one or more features of the element on the computer GUI and the plurality of GUI elements on the map.

Example No. 20 includes all the features of Example Nos. 16-19, and optionally includes wherein the computer system is operable for highlighting the matched GUI element on a second computer GUI that is associated with a second user; and for executing the command in connection with the matched GUI element on a second computer GUI that is associated with a second user.

1. A process comprising:
receiving into a natural language processor (NLP) from a user one or more of an audible command and an audible description of an element on a computer graphical user interface (GUI);
extracting from the audible description one or more features of the element on the computer GUI;
transmitting a screenshot of the computer GUI to a computer vision platform;
receiving from the computer vision platform a map of features of a plurality of GUI elements that are displayed on the computer GUI;
comparing the one or more features of the element on the computer GUI with the features of the plurality of GUI elements on the map;
identifying a match between the one or more features of the element on the computer GUI and the features of the plurality of GUI elements on the map; and
executing the audible command in connection with the matched GUI element.

2. The process of claim 1, wherein the one or more features of the element on the computer GUI and the features of the plurality of GUI elements on the map comprise one or more of a location, a color, a shape, and a text segment.

3. The process of claim 1, comprising receiving into the NLP from the user a second audible description of the element on the computer GUI when the identifying a match identifies no matched GUI elements or the identifying a match identifies two or more matched GUI elements.

4. The process of claim 1, wherein the identifying the match identifies a best match from the features of the plurality of GUI elements on the map using a statistical analysis.

5. The process of claim 1, comprising computing a confidence level for the match between the one or more features of the element on the computer GUI and the features of the plurality of GUI elements on the map.

6. The process of claim 1, comprising highlighting the matched GUI element on a second computer GUI that is associated with a second user.

7. The process of claim 1, comprising executing the command in connection with the matched GUI element on a second computer GUI that is associated with a second user.

8. The process of claim 1, wherein the computer GUI comprises an entertainment service, and comprising executing the command in connection with a program associated with the entertainment service.

9. A non-transitory machine-readable medium comprising instructions that when executed by a processor execute a process comprising:
receiving into a natural language processor (NLP) from a user one or more of an audible command and an audible description of an element on a computer graphical user interface (GUI);
extracting from the audible description one or more features of the element on the computer GUI;
transmitting a screenshot of the computer GUI to a computer vision platform;
receiving from the computer vision platform a map of features of a plurality of GUI elements that are displayed on the computer GUI;
comparing the one or more features of the element on the computer GUI with the features of the plurality of GUI elements on the map;
identifying a match between the one or more features of the element on the computer GUI and the features of the plurality of GUI elements on the map; and
executing the audible command in connection with the matched GUI element.

10. The non-transitory machine-readable medium of claim 9, wherein the one or more features of the element on the computer GUI and the features of the plurality of GUI elements on the map comprise one or more of a location, a color, a shape, and a text segment.

11. The non-transitory machine-readable medium of claim 9, comprising instructions for receiving into the NLP from the user a second audible description of the element on the computer GUI when the identifying a match identifies no matched GUI element or the identifying a match identities two or more matched GUI elements.

12. The non-transitory machine-readable medium of claim 9, wherein the identifying the match identifies a best match from the features of the plurality of GUI elements on the map using a statistical analysis.

13. The non-transitory machine-readable medium of claim 9, comprising instructions for computing a confidence level for the match between the one or more features of the element on the computer GUI and the features of the plurality of GUI elements on the map.

14. The non-transitory machine-readable medium of claim 9, comprising instructions for highlighting the matched GUI element on a second computer GUI that is associated with a second user.

15. The non-transitory machine-readable medium of claim 9, comprising instructions for executing the command in connection with the matched GUI element on a second computer GUI that is associated with a second user.

16. A computer system comprising:
a processor; and
a memory coupled to the processor;
wherein the processor and the memory are operable for:
receiving into a natural language processor (NLP) from a user one or more of an audible command and an audible description of an element on a computer graphical user interface (GUI);
extracting from the audible description one or more features of the element on the computer GUI;
transmitting a screenshot of the computer GUI to a computer vision platform;
receiving from the computer vision platform a map of features of a plurality of GUI elements that are displayed on the computer GUI;
comparing the one or more features of the element on the computer GUI with the features of the plurality of GUI elements on the map;
identifying a match between the one or more features of the element on the computer GUI and the features of the plurality of GUI elements on the map; and
executing the audible command in connection with the matched GUI element.

17. The computer system of claim 16, wherein the one or more features of the element on the computer GUI and the features of the plurality of GUI elements on the map comprise one or more of a location, a color, a shape, and a text segment.

18. The computer system of claim 16, wherein the computer system is operable for receiving into the NLP from the user a second audible description of the element on the computer GUI when the identifying a match identifies no matched GUI element or the identifying a match identifies two or more matched GUI elements.

19. The computer system of claim 16, wherein the computer system is operable for identifying a best match from the features of the plurality of GUI elements on the map using a statistical analysis; and for computing a confidence level for the match between the one or more features of the element on the computer GUI and the features of the plurality of GUI elements on the map.

20. The computer system of claim 16, wherein the computer system is operable for highlighting the matched GUI element on a second computer GUI that is associated with a second user; and for executing the command in connection with the matched GUI element on a second computer GUI that is associated with a second user.
